(19) United States
(12) Patent Application Publication
(10) Pub. No.: US 2008/0183677 A1
(43) Pub. Date: Jul. 31, 2008

(54) COMPUTER-READABLE RECORDING MEDIUM STORING ANNIVERSARY NOTIFYING PROGRAM, ANNIVERSARY NOTIFYING METHOD, AND MOBILE TERMINAL

(75) Inventors: Eriko ITO, Kawasaki (JP); Atsushi ITO, Kawasaki (JP); Naoto NISHIYAMA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/947,383

(22) Filed: Nov. 29, 2007

(30) Foreign Application Priority Data
Jan. 29, 2007 (JP) 2007-018050

(51) Int. Cl. G06F 7/06; G06F 17/30

(52) U.S. Cl. 707/3; 707/100; 707/E17.001; 707/E17.014

(57) ABSTRACT

A mobile terminal controls an operation of an application such that the application which causes data recording records data related to the anniversary around a same time that the anniversary is notified. To be specific, the mobile terminal monitors whether a user has carried out an operation on the mobile terminal after the anniversary is notified. Upon the user carrying out an operation on the mobile terminal (any operation (for example, pressing a button of an operating unit etc.), the mobile terminal controls the operation by activating the application. The mobile terminal controls the operation by activating as the application, an imaging application that shoots and records an image, a memo input application that receives and records a memo input, and a mail application that transmits and records a mail.

### BACKGROUND OF THE INVENTION

1. Field of the Invention

The present invention relates to a computer-readable recording medium storing an anniversary notifying program, an anniversary notifying method, and a mobile terminal.

2. Description of the Related Art

Various technologies are commonly used for prevention of forgetting an anniversary. For example, in a device suggested in Japanese Patent Application Laid-open No. 2002-262150 (pages 1 to 3), an electronic device such as a digital camera stores a birthday and uses the stored birthday as a standard to calculate and display a plurality of anniversaries (for example, “oshichiya” which is a celebration feast a family have on the seventh day after the birth of a child, “omiya-mairi” which is an event to celebrate the birth of a child by paying a visit to a shrine after approximately one month after the birth of the child, and the like).

However, in a conventional technology mentioned above, although a user is notified of the anniversary, if the user is not sufficiently keen to take a commemorative photograph (for example, if the user feels that a recording operation is complex due to a busy schedule, or if the user forgets), the anniversary ends before the user takes the commemorative photograph. In other words, regardless of being notified of the anniversary, if the user is not sufficiently keen to record data related to the anniversary, the data related to the anniversary cannot be recorded.

### SUMMARY OF THE INVENTION

It is an object of the present invention to at least partially solve the problems in the conventional technology.

According to one aspect of the present invention, a computer-readable recording medium that stores therein a computer program that causes a computer embodied in a mobile terminal to execute a method of notifying that an anniversary has arrived, the computer program causing the computer to execute anniversary operation controlling in which an operation, of an application that causes data recording, is controlled such that the application records data related to the anniversary around a same time that the anniversary is notified.

According to another aspect of the present invention, a method of notifying that an anniversary has arrived by a mobile terminal, includes anniversary operation controlling in which an operation, of an application that causes data recording, is controlled such that the application records data related to the anniversary around a same time that the anniversary is notified.

According to still another aspect of the present invention, a mobile terminal for notifying that an anniversary has arrived includes an anniversary operation controller that controls an operation, of an application that causes data recording, such that the application records data related to the anniversary around a same time that the anniversary is notified.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining an overview and a feature of a mobile terminal according to a first embodiment of the present invention;

FIG. 2 is a block diagram of the mobile terminal according to the first embodiment;

FIG. 3 is a schematic of an example of anniversary definitions that are stored in an anniversary definition-storage unit according to the first embodiment;

FIG. 4 is a schematic of an example of an anniversary that is stored in an anniversary storage unit according to the first embodiment;

FIG. 5 is a schematic of an example of an anniversary record that is stored in an anniversary record-storage unit according to the first embodiment;

FIG. 6 is a schematic of an example of a screen at the time of anniversary input in the first embodiment;

FIG. 7 is a schematic of an example of a screen that notifies an anniversary in the first embodiment;

FIGS. 8A to 8C are schematics of an example of an operation at the time of anniversary operation control in the first embodiment;

FIG. 9 is a flowchart of a process at the time of anniversary setting in the first embodiment;

FIG. 10 is a flowchart of a process at the time of the anniversary operation control in the first embodiment;

FIG. 11 is a schematic of an example of an anniversary log definition in a second embodiment of the present invention;

FIGS. 12A to 12C are schematics for explaining an example of a process for displaying an anniversary record of a past anniversary in the second embodiment;

FIG. 13 is a schematic of an example of anniversary definitions stored in an anniversary definition table that includes address data of a mail in the second embodiment;

FIG. 14 is a schematic of an example of a screen that is output after an input of a relevant mail address in an address column of the mail in the second embodiment;

FIGS. 15A to 15D are schematics for explaining a feature of a mobile terminal according to the second embodiment that reactivates an application after a predetermined time period; and

FIG. 16 is a block diagram of an anniversary notifying program according to the first embodiment.

### DETAILED DESCRIPTION OF THE PREFERRED EMBODIMENTS

Exemplary embodiments of the computer-readable recording medium storing the anniversary notifying program, the anniversary notifying method, and the mobile terminal according to the present invention are explained below with reference to the accompanying drawings. In the embodiments explained below, the present invention is applied to a mobile terminal (for example, a mobile phone, a personal handy-phone system (PHS), a personal digital assistant (PDA) etc.). An overview and a feature of the mobile terminal according to a first embodiment of the present invention and a structure and a process sequence of the mobile terminal are sequentially explained.

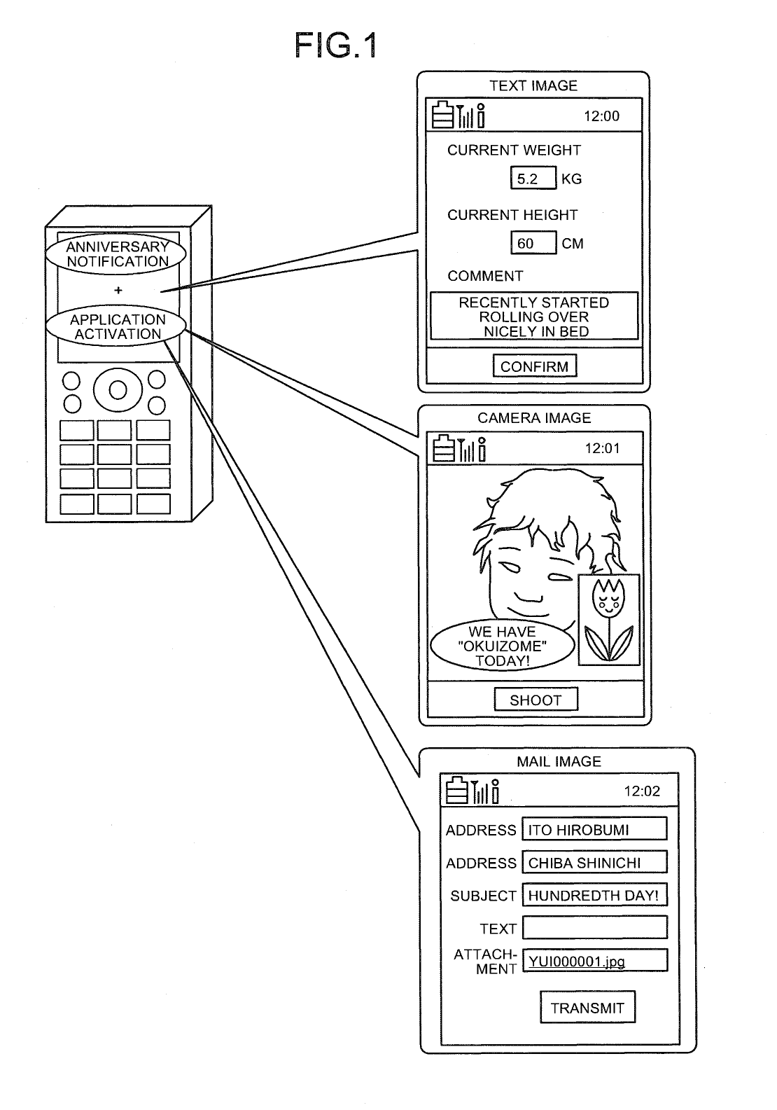

First, the overview and the feature of the mobile terminal according to the first embodiment are explained with reference to FIG. 1. FIG. 1 is a schematic for explaining the overview and the feature of the mobile terminal according to the first embodiment.

As shown in FIG. 1, the mobile terminal according to the first embodiment notifies that an anniversary has arrived. According to the feature that is explained below, even if a user is not sufficiently keen to record data related to the anniversary, the mobile terminal can record the data related to the anniversary.

In other words, the mobile terminal according to the first embodiment controls an operation of an application such that the application which causes data recording records data related to the anniversary around a same time that the anniversary is notified. To be specific, after notifying the user of the anniversary, the mobile terminal monitors whether the user has carried out an operation (any operation on the mobile terminal (for example, pressing a button of an operating unit etc.)) on the mobile terminal. If the user has carried out an operation, the mobile terminal controls the operation by activating a memo input application that receives and records a memo input, an imaging operation that shoots and records an image, and a mail application that transmits and records a mail.

Thus, due to the feature mentioned above, even if the user is not sufficiently keen to record the data related to the anniversary, the mobile terminal according to the first embodiment can record the data related to the anniversary.

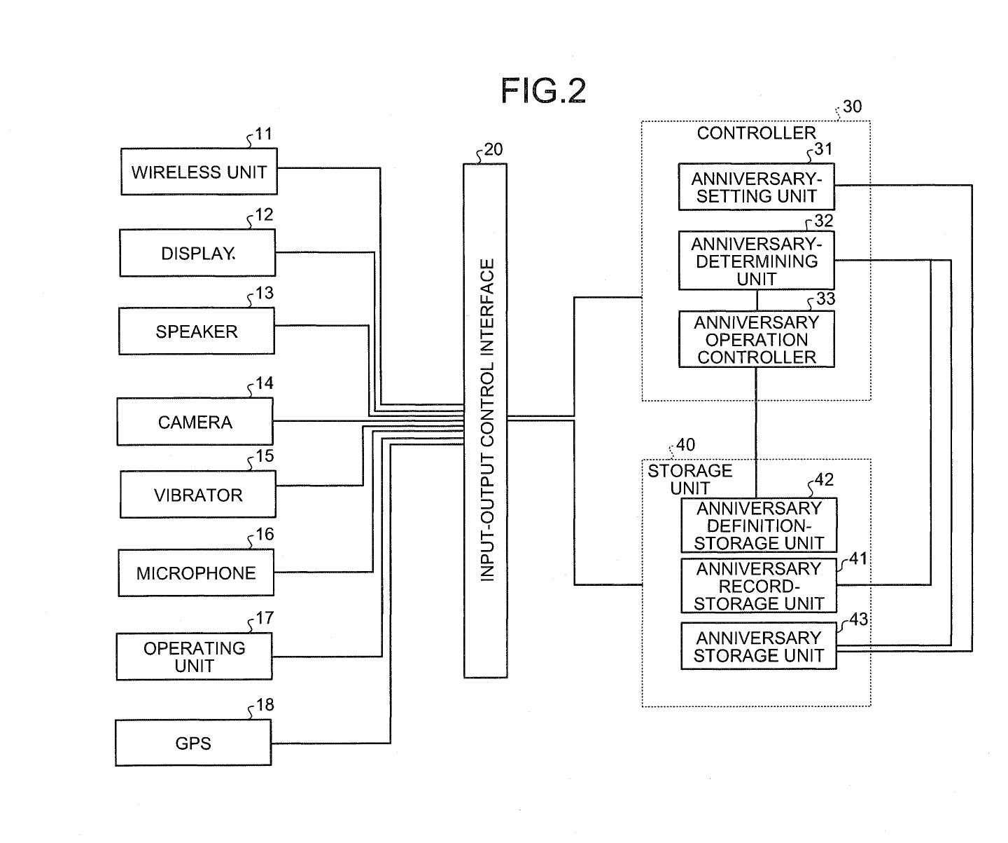

The structure of the mobile terminal according to the first embodiment is explained with reference to FIG. 2. FIG. 2 is a block diagram of the mobile terminal according to the first embodiment. As shown in FIG. 2, the mobile terminal includes a wireless unit 11, a display 12, a speaker 13, a camera 14, a vibrator 15, a microphone 16, an operating unit 17, a global positioning system (GPS) 18, an input-output control interface 20, a controller 30, and a storage unit 40.

The wireless unit 11 receives electromagnetic waves or emits electromagnetic waves. Further, the wireless unit 11 carries out a process to rebuild communication data based on the electromagnetic waves that are received by the mobile terminal and a process to convert the communication data that is to be emitted from the mobile terminal into the electromagnetic waves.

The display 12 is a display (for example, a liquid crystal display, an organic light emitting (EL) display etc.) that displays a text or a drawing. The speaker 13 is used for producing a sound. For example, upon the mobile terminal receiving a phone call or a mail, the speaker 13 produces a ringing sound. The camera 14 shoots an image and generates data related to the shot image. The vibrator 15 vibrates the mobile terminal. The microphone 16 collects surrounding sounds. For example, the microphone 16 collects the user's voice at the time of voice communication.

The operating unit 17 receives an operation from the user and transmits operation content from the user to the mobile terminal. For example, the operating unit 17 includes a numerical keypad, an operating key, a rotation selector, a cursor, arrow keys, a setting key, a deciding key, a responding key, an end key (power key) etc. The GPS 18 is a device for checking a current location of the mobile terminal.

The input-output control interface 20 controls transmission of various types of data among the wireless unit 11, the display 12, the speaker 13, the camera 14, the vibrator 15, the microphone 16, the operating unit 17, the GPS 18, the controller 30, and the storage unit 40.

The storage unit 40 stores therein data and programs that are necessary for various processes. As shown in FIG. 2, the storage unit 40 stores therein an anniversary record-storage unit 41, an anniversary definition-storage unit 42, and an anniversary storage unit 43 as units that are closely related to the present invention.

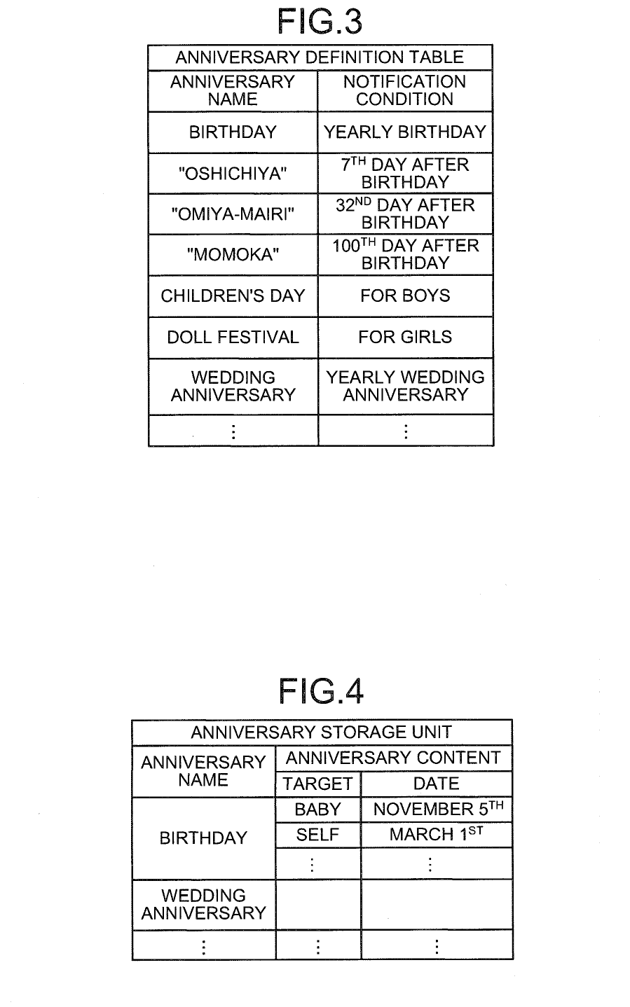

The anniversary definition-storage unit 42 stores therein a definition related to the anniversary that is used by a later explained anniversary-determining unit 32 to determine whether the anniversary has arrived. To be specific, as shown in FIG. 3, the anniversary definition-storage unit 42 stores in “anniversary definition table”, a correspondence between “anniversary name” that indicates a name of an anniversary and “notification condition” that indicates a condition for determining and notifying an anniversary. The anniversary definition-storage unit 42 is a nonvolatile memory, for example.

For example, in the example shown in FIG. 3, the anniversary definition-storage unit 42 stores in the anniversary definition table, a correspondence between “birthday” as “anniversary name” and “yearly birthday” as “notification condition”. Similarly, the anniversary definition-storage unit 42 stores in the anniversary definition table, a correspondence between “oshichiya” as “anniversary name” and “7^{th} day after birthday” as “anniversary condition”, a correspondence between “omiya-mairi” as “anniversary name” and “32^{nd} day after birthday” as “anniversary condition”, and a correspondence between “momoka” as “anniversary name” and “hundredth day after birthday” as “anniversary condition”. FIG. 3 is a schematic of an example of the anniversary definitions that are stored in the anniversary definition-storage unit 42 according to the first embodiment.

The anniversary storage unit 43 stores the anniversary that is notified by the mobile terminal. To be specific, as shown in FIG. 4, the anniversary storage unit 43 stores a correspondence between “anniversary name” and “anniversary content” that indicates content of the anniversary. Further, the anniversary storage unit 43 stores as “anniversary content”, “target” that indicates a person for whom the day is the anniversary and “date” that indicates a date of the anniversary.

For example, as shown in FIG. 4, the anniversary storage unit 43 stores therein a correspondence among “birthday”, “baby”, and “November 5th” as “anniversary name”, “target”, and “date”, respectively. Similarly, the anniversary storage unit 43 stores a correspondence among “birthday”, “self”, and “March 1st”. FIG. 4 is a schematic of an example of the anniversaries that are stored in the anniversary storage unit 43 according to the first embodiment.

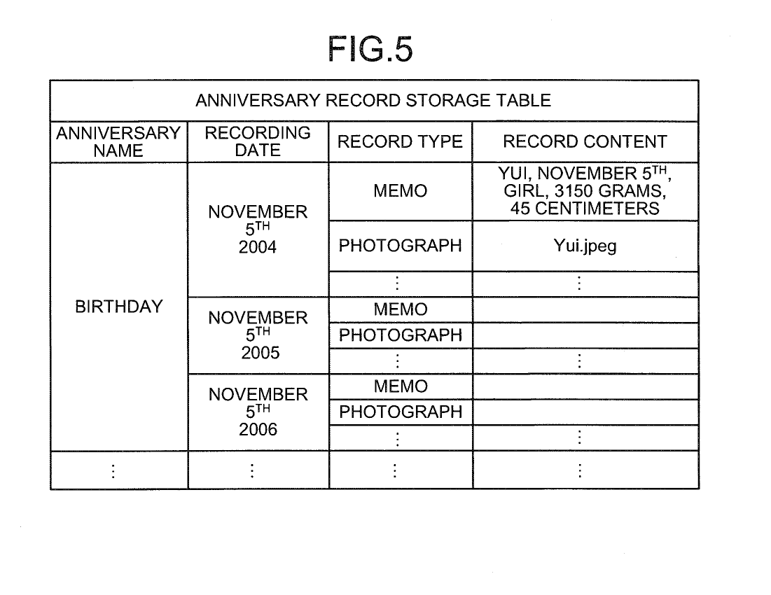

The anniversary record-storage unit 41 stores the data related to the anniversary. To be specific, as shown in FIG. 5, the anniversary record-storage unit 41 stores in “anniversary record storage table”, a correspondence among “anniversary name”, “recording date” that indicates a date when the data related to the anniversary is recorded, “record type” that indicates a type of the recorded data, and “record content” that indicates the recorded data.

For example, in the example shown in FIG. 5, the anniversary record-storage unit 41 stores in “anniversary record storage table”, a correspondence between “birthday” as “anniversary name” and “Nov. 5, 2004” as “recording date”. Similarly, the anniversary record-storage unit 41 stores in “anniversary record storage table” a correspondence between “memo” as “record type” and “Yui, November 5^{th}, girl, 3150 grams, 45 centimeters” as “record content”. Further, the anniversary record-storage unit 41 stores in “anniversary record storage table” a correspondence between “photograph” and “yui.jpeg”. FIG. 5 is a schematic of an example of an anniversary record that is stored in the anniversary record-storage unit 41 according to the first embodiment.

The controller 30 includes an internal memory for storing therein a control program such as an operating system (OS), a program that regulates various process sequences, and necessary data. The controller 30 uses the control program, the program, and the data to execute various processes and controls the mobile terminal notifying the anniversary. As shown in FIG. 2, the controller 30 includes an anniversary-setting unit 31, an anniversary-determining unit 32, and an anniversary operation controller 33 as units that are closely related to the present invention. The anniversary operation controller 33 is a unit that performs anniversary operation control.

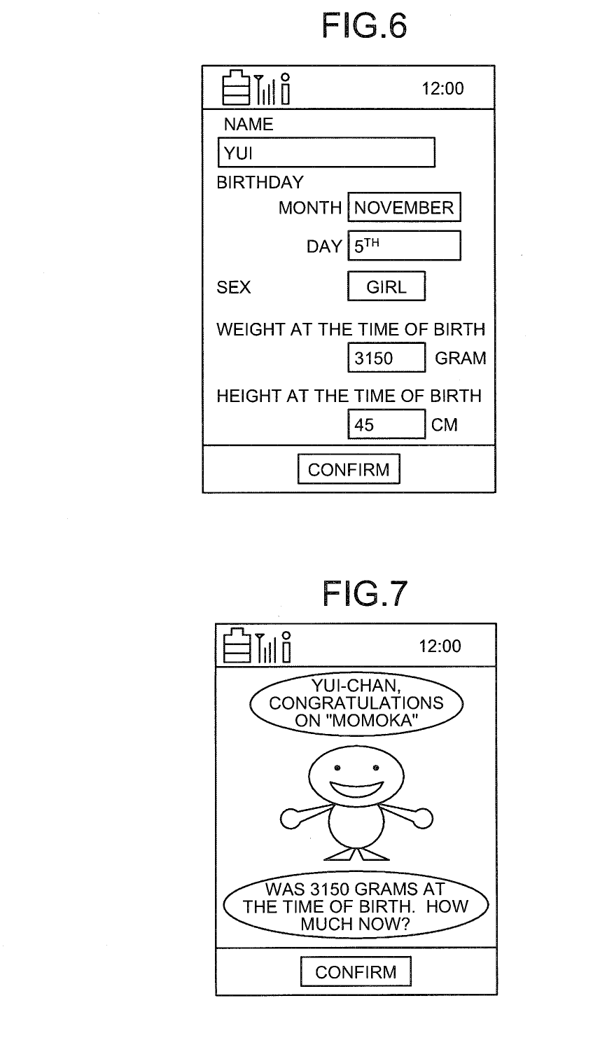

The anniversary-setting unit 31 stores the input anniversary in the anniversary storage unit 43. To be specific, as shown in FIG. 6, the anniversary-setting unit 31 outputs a screen which includes a field that receives “name” that indicates the person whose birthday (anniversary) is input, a field that receives “birthday” (in other words, “month” and “day”) that indicates a birthday, a field that receives “sex” that indicates a sex of a person who is an anniversary target, a field that receives “weight at the time of birth” that indicates a weight at the time of birth of the person who is the anniversary target, a field that receives “height at the time of birth” that indicates a height at the time of birth of the person who is the anniversary target, and a button that receives “confirm” instruction (an instruction to record a setting of the anniversary).

For example, in the example shown in FIG. 6, upon the operating unit 17 inputting “Yui” as “name”, “November” as “month”, “5^{th}” as “day”, “girl” as “sex”, “3150” as “weight at the time of birth”, and “45” as “height at the time of birth”, the anniversary-setting unit 31 stores each of the inputs in the anniversary storage unit 43. FIG. 6 is a schematic of an example of the screen at the time of anniversary input in the first embodiment.

The anniversary-determining unit 32 determines whether a day is the anniversary. If the day is the anniversary, the anniversary-determining unit 32 notifies that the anniversary has arrived. To be specific, at a predetermined timing every day (for example, in the morning or in the afternoon) the anniversary-determining unit 32 calculates a next anniversary based on the anniversary definition stored in the anniversary definition-storage unit 42 and the anniversary stored in the anniversary storage unit 43, compares the calculated next anniversary with a current date, and determines whether the calculated next anniversary matches with the current date. If the calculated next anniversary matches with the current date, the anniversary-determining unit 32 determines that the current date is the anniversary, and notifies that the anniversary has arrived. For example, as shown in FIG. 7, the anniversary-determining unit 32 notifies from the display 12 that the anniversary (such as “momoka”) has arrived. FIG. 7 is a schematic of an example of the screen that notifies the anniversary in the first embodiment.

The anniversary operation controller 33 controls the operation of the application such that the application that causes the data recording records the data related to the anniversary around the same time that the anniversary is notified. To be specific, after the notification of the anniversary, the anniversary operation controller 33 monitors whether the user has carried out an operation (any operation on the mobile terminal (for example, pressing the button of the operating unit 17 etc.)) on the mobile terminal. If the user has carried out an operation on the mobile terminal, the anniversary operation controller 33 controls the operation by activating the application.

To be further specific, the anniversary operation controller 33 controls the operation by activating as the application mentioned earlier, the memo input application that receives and records the memo input, the imaging operation that shoots and records an image, and the mail application that transmits and records a mail.

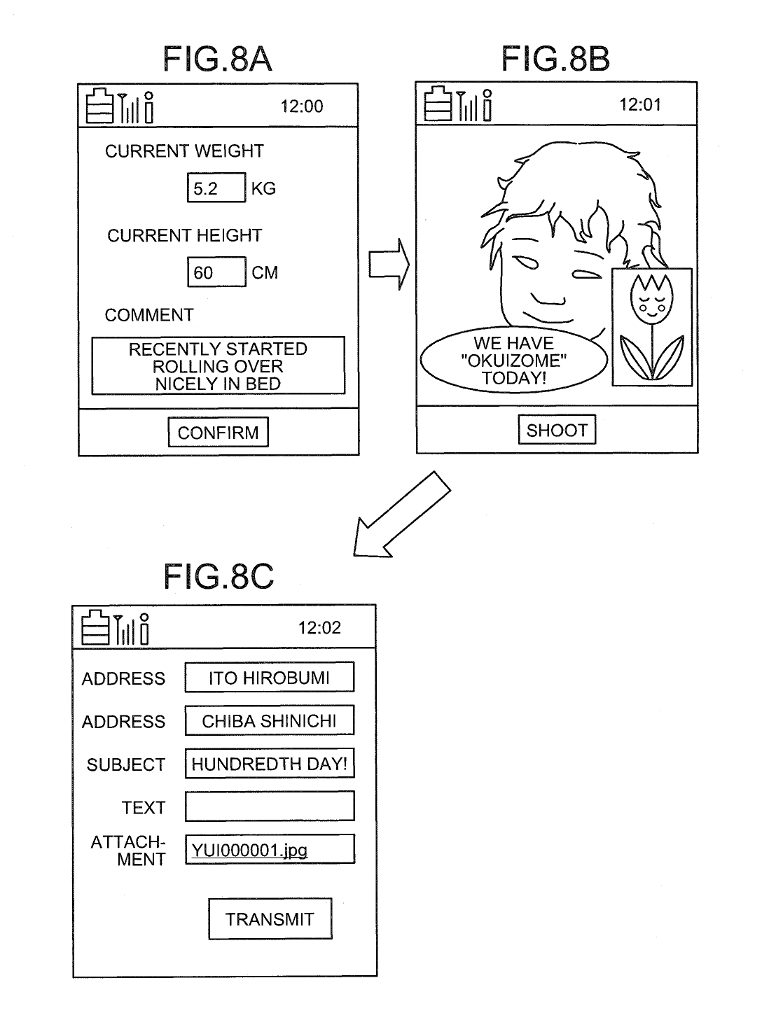

For example, upon the anniversary-determining unit 32 notifying that the anniversary has arrived, the anniversary operation controller 33 activates the memo input application to output an anniversary input screen from the display 12 and records the memo related to the anniversary. In an example shown in FIG. 8A, the anniversary operation controller 33 outputs a screen that includes a field that receives “current weight”, a field that receives “current height”, a field that receives “comment”, and a button that receives “confirm” instruction (to end the input of the memo related to the anniversary) (see FIG. 8A). Upon receiving “confirm” instruction after the user has input via the operating unit 17, “5.7 kilograms (kg)” as “current weight”, “60 (cm)” as “current height”, and “recently started rolling over in bed skillfully” as “comment”, the anniversary operation controller 33 records the input memo in the anniversary record-storage unit 41. FIGS. 8A to 8C are schematics of an example of the operation at the time of anniversary operation control in the first embodiment.

For example, upon receiving the input of the memo related to the anniversary, the anniversary operation controller 33 activates the imaging application, outputs an imaging screen from the display 12, and records an image related to the anniversary. In the example shown in FIG. 8B, the anniversary operation controller 33 outputs a screen that displays the image taken by the camera 14 and that includes a button that receives “shoot” (to shoot an image) instruction (see FIG. 8B). Thereafter, upon receiving “shoot” instruction, the anniversary operation controller 33 records the shot image in the anniversary record-storage unit 41.

Next, for example, upon receiving the shot image related to the anniversary, the anniversary operation controller 33 activates the mail application, outputs a mail transmission screen from the display 12, and records a mail related to the anniversary. In the example shown in FIG. 8C, the anniversary operation controller 33 outputs a screen that includes a field that receives “address”, a field that receives “subject” (a subject column), a field that receives “text” (text of the mail that is transmitted), a field that receives “attachments” (the image that is attached to the mail and transmitted), and a button that receives “transmit” (to transmit the mail) instruction (see FIG. 8C). Thereafter, upon receiving “transmit” instruction, the anniversary operation controller 33 records the input memo in the anniversary record-storage unit 41.

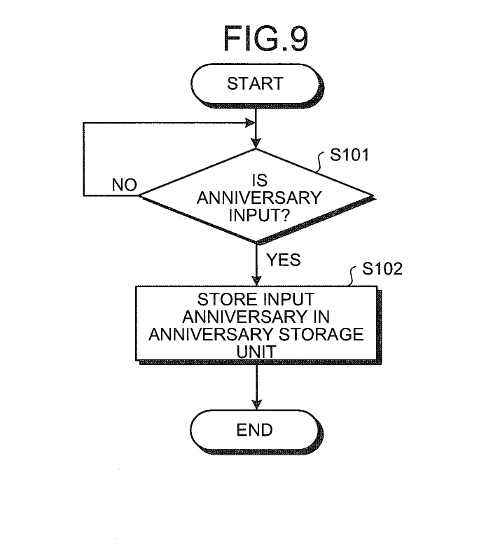

A process sequence at the time of anniversary setting in the first embodiment is explained next with reference to FIG. 9. FIG. 9 is a flowchart of a process at the time of the anniversary setting in the first embodiment.

As shown in FIG. 9, upon an input of the anniversary (Yes at step S101), the anniversary-setting unit 31 stores the input anniversary in the anniversary storage unit 43 (step S102). For example, upon the operating unit 17 inputting “Yui” as “name”, “November” as “month”, “5^{th}” as “day”, “girl” as “sex”, “3150” as “weight at the time of birth”, and “45” as “height at the time of birth”, the anniversary-setting unit 31 stores each of the fields mentioned earlier in the anniversary storage unit 43.

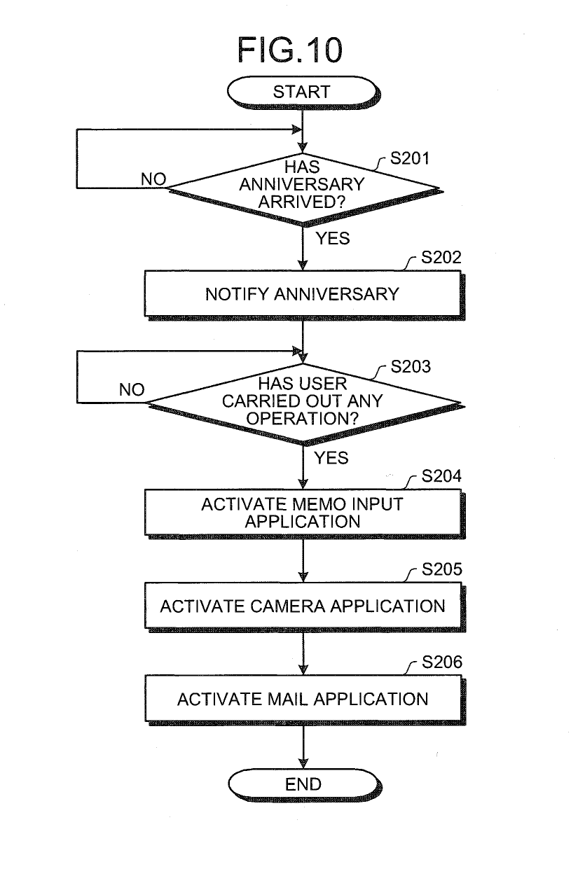

A process sequence at the time of anniversary operation control in the first embodiment is explained next with reference to FIG. 10. FIG. 10 is a flowchart of the process at the time of the anniversary operation control in the first embodiment.

As shown in FIG. 10, the anniversary-determining unit 32 determines whether the current date is the anniversary (step S201). If the current date is the anniversary (Yes at step S201), the anniversary-determining unit 32 notifies that the current date is the anniversary (step S202). In other words, the anniversary-determining unit 32 notifies that the anniversary has arrived.

Then, the anniversary operation controller 33 monitors whether the user has carried out an operation (any operation on the mobile terminal (pressing the button of the operating unit 17 etc.)) (step S203). In other words, the anniversary operation controller 33 monitors whether the user has carried out an operation on the mobile terminal after the anniversary is notified.

If the user has carried out an operation (Yes at step S203), the anniversary operation controller 33 controls the operation of the application such that the application that causes the data recording records the data related to the anniversary (steps S204 to S206). For example, the anniversary operation controller 33 activates the memo input application to output the anniversary input screen from the display 12 and records the memo related to the anniversary (step S204). Next, the anniversary operation controller 33 activates the imaging application to display the imaging screen from the display 12 and records the image related to the anniversary (step S205). Next, the anniversary operation controller 33 activates the mail application to display the mail transmission screen from the display 12 and records the mail related to the anniversary (step S206).

According to the first embodiment, the mobile terminal controls the operation of the application such that the application that causes the data recording records the data related to the anniversary around the same time that the anniversary is notified. Due to this, even if the user is not sufficiently keen to record the data related to the anniversary, the mobile terminal can record the data related to the anniversary.

Further, according to the first embodiment, the mobile terminal monitors whether the user has carried out an operation on the mobile terminal after the anniversary is notified. If the user has carried out an operation on the mobile terminal, the mobile terminal controls the operation by activating the application. Therefore, a timing to activate the application can be controlled based on only whether the user has carried out an operation. Thus, a further simplified process can be realized and the application can be activated during the timing when the user is carrying the mobile terminal.

Further, according to the first embodiment, the mobile terminal controls the operation by activating as the application, the imaging application that shoots and records the image. Therefore, even if the user is not sufficiently keen to preserve a commemorative photograph, the commemorative photograph can be preserved.

Further, according to the first embodiment, the mobile terminal controls the operation by activating as the application, the memo input application that receives and records the memo input. Therefore, even if the user is not sufficiently keen to preserve a memo related to the anniversary, the memo related to the anniversary can be preserved.

Further, according to the first embodiment, the mobile terminal controls the operation by activating as the application, the mail application that transmits and records the mail. Therefore, even if the user is not sufficiently keen to transmit the mail related to the anniversary, the mail related to the anniversary can be transmitted.

The mobile terminal according to the first embodiment has been explained. The present invention, however, can be implemented in various embodiments other than that explained above. Hereinbelow, another embodiment is explained as a mobile terminal according to a second embodiment.

In the first embodiment, the mobile terminal sequentially activates as the application, the memo input application, the imaging application, and the mail application. However, the present invention is not to be thus limited, and it is possible to activate only a part of the applications (for example, only the mail application or only the imaging application and the memory input application etc.), or to change the order of activation of the applications (for example, it is possible to activate the applications in the sequence of the imaging application, the memo input application, and the mail application etc.).

Further, in the first embodiment, the mobile terminal uses the application to record the data that is input as the data of the anniversary from the user. However, the present invention is not to be thus limited, and an operation history of the mobile terminal can also be recorded.

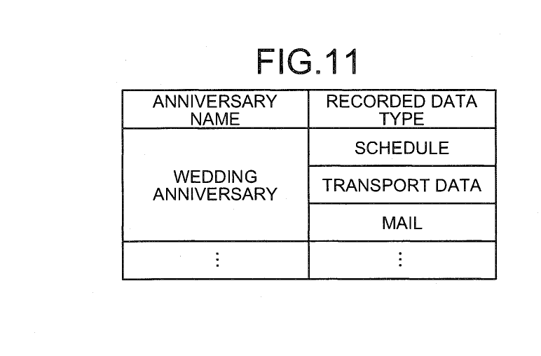

To be specific, the mobile terminal controls the operation by activating as the application, a log application that records the operation history of the mobile terminal as a log. For example, in an example shown in FIG. 11, the mobile terminal stores a correspondence between “anniversary name” and “recorded data type” that indicates a type of the log that is stored as the operation history of the mobile terminal. If the anniversary is “wedding anniversary”, the mobile terminal stores in “recorded data type”, “schedule” (for example, a schedule of the day that is stored in the mobile terminal), “transport data” (for example, a location data of the day that is obtained via the GPS 18), and “mail” (for example, mails that are transceived from a prior set person). FIG. 11 is a schematic of an example of an anniversary log definition in the second embodiment.

Thus, the mobile terminal controls the operation by activating as the application, the log application that records the operation history of the mobile terminal as the log. Therefore, even if the user is not sufficiently keen to record events that occurred on the anniversary, data (for example, content that is set in the schedule etc.) that indicates the events occurred on the anniversary can be recorded.

In the first embodiment, the mobile terminal records the data related to the anniversary along with the notification of the anniversary and ends the process. However, the present invention is not to be thus limited, and data of a related past anniversary can be output around the same time that the anniversary is notified.

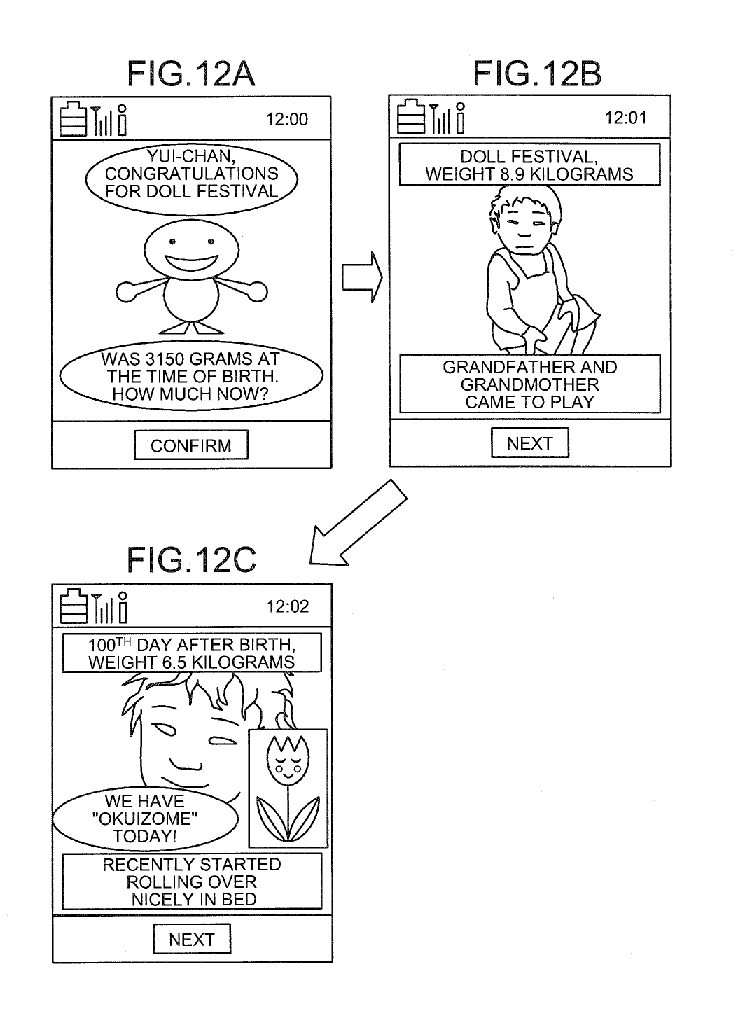

To be specific, the mobile terminal stores in a predetermined storage unit, a correspondence between the data related to the anniversary and the anniversary. Along with the notification of the anniversary, the mobile terminal searches from the predetermined storage unit, the data corresponding to the past anniversary related to the anniversary, and outputs the searched data. For example, in an example shown in FIGS. 12A to 12C, after notifying that Doll Festival (anniversary) has arrived (see FIG. 12A), the mobile terminal displays data related to the Doll Festival that is recorded in the past (see FIG. 12B). Next, the mobile terminal displays data related to the 100^{th} day after the birth (data corresponding to the related past anniversary) (see FIG. 12C). FIGS. 12A to 12C are schematics for explaining an example of a process for displaying an anniversary record of a past anniversary in the second embodiment.

Thus, the mobile terminal stores a correspondence between the data related to the anniversary and the anniversary. Along with the notification of the anniversary, the mobile terminal searches data corresponding to the past anniversary related to the anniversary and outputs the searched data. Therefore, even if the user is not sufficiently keen to confirm data of the related past anniversary, the data of the related past anniversary can be confirmed.

In the embodiment explained above, the mobile terminal activates the memo input application, the imaging application, the mail application, and a log application. However, the present invention is not to be thus limited, and the mobile terminal can also activate other applications that record the data of the anniversary (for example, an application that records a sound of the anniversary (a baby's voice etc.)).

In the first embodiment explained earlier, the mobile terminal causes the user to input required entries into the subject column that are necessary for mail transmission. However, the present invention is not to be thus limited, and the necessary entries can be input into the subject column by the mobile terminal itself.

To be specific, when controlling the operation by activating the mail application, the mobile terminal outputs in the mobile terminal itself, a mail for transmission in which the subject corresponding to the anniversary is prior written in the subject column. For example, for “momoka” (anniversary), the mobile terminal inputs “hundredth day!” in the subject column and outputs the mail from the display 12 (see FIG. 8C).

Thus, when controlling the operation by activating the mail application, the mobile terminal outputs in the mobile terminal itself, the mail for transmission in which the subject corresponding to the anniversary is prior written in the subject column. Therefore, the mail related to the anniversary can be sent without inputting the subject in the subject column of the mail that is transmitted.

In the first embodiment explained earlier, the mobile terminal causes the user to input a required entry into an address column that is necessary for mail transmission. However, the present invention is not to be thus limited, and the necessary entry can be input into the address column by the mobile terminal itself.

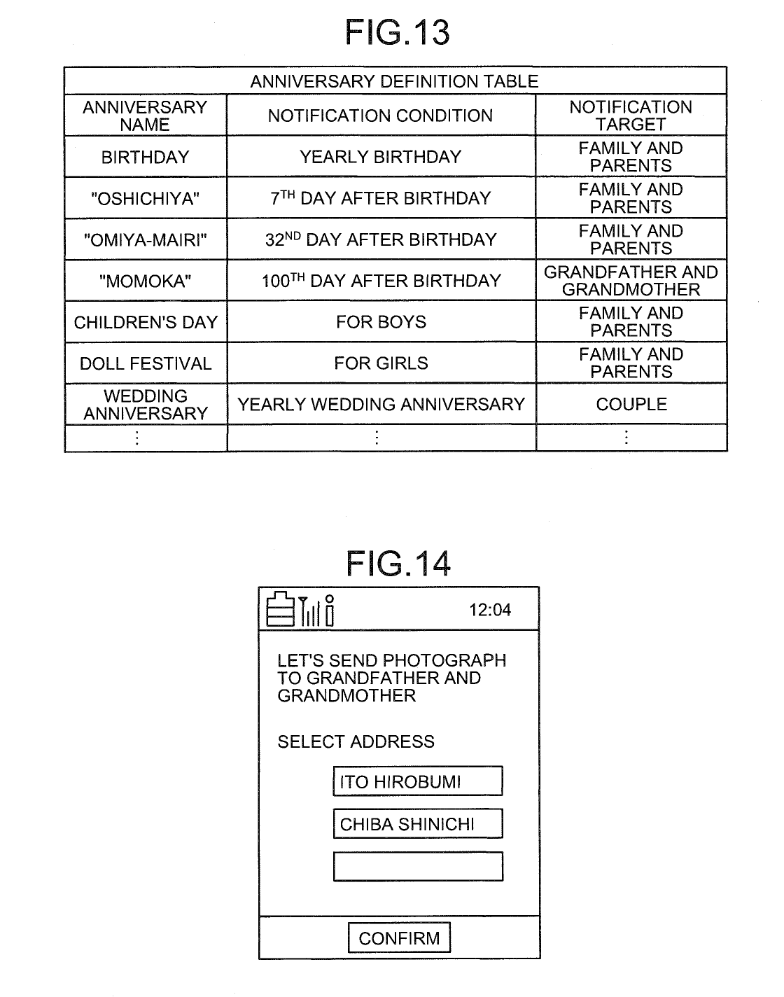

To be specific, when controlling the operation by activating the mail application, the mobile terminal outputs in the mobile terminal itself, the mail for transmission in which a mail address of a person related to the anniversary is prior written in the address column. For example, in the example shown in FIG. 13, the mobile terminal stores a correspondence among “anniversary name”, “notification condition”, and “notification target” that indicates a target for transmitting the mail to the effect that the anniversary has arrived. For example, the mobile terminal stores a correspondence among “momoka” as “anniversary name”, “hundredth day after birth” as “notification condition” and “grandfather, grandmother” as “notification target”.

Next, the mobile terminal determines that a mail needs to be transmitted to “grandfather, grandmother” on “momoka”, inputs the relevant mail address into the address column, and outputs the mail from the display 12. For example, as shown in FIG. 14, the mobile terminal inputs “Ito Hirobumi” and “Chiba Shinichi” which are the mail addresses corresponding to “grandfather, grandmother” into the address columns, and outputs from the display 12. FIG. 13 is a schematic of an example of the anniversary definition stored in the anniversary definition table that includes address data of the mail in the second embodiment. FIG. 14 is a schematic of an example of a screen that is output after the relevant mail address is input in the address column of the mail in the second embodiment.

Thus, when controlling the operation by activating the mail application, the mobile terminal outputs in the mobile terminal itself, the mail for transmission in which the mail address of the person related to the anniversary is prior written in the address column. Therefore, the mail related to the anniversary can be transmitted simply by generating content of the mail for transmission without inputting a destination.

In the first embodiment explained earlier, the mobile terminal activates the application when notifying that the anniversary has arrived. However, the present invention is not to be thus limited, and the mobile terminal can also activate the application intermittently after notifying that the anniversary has arrived.

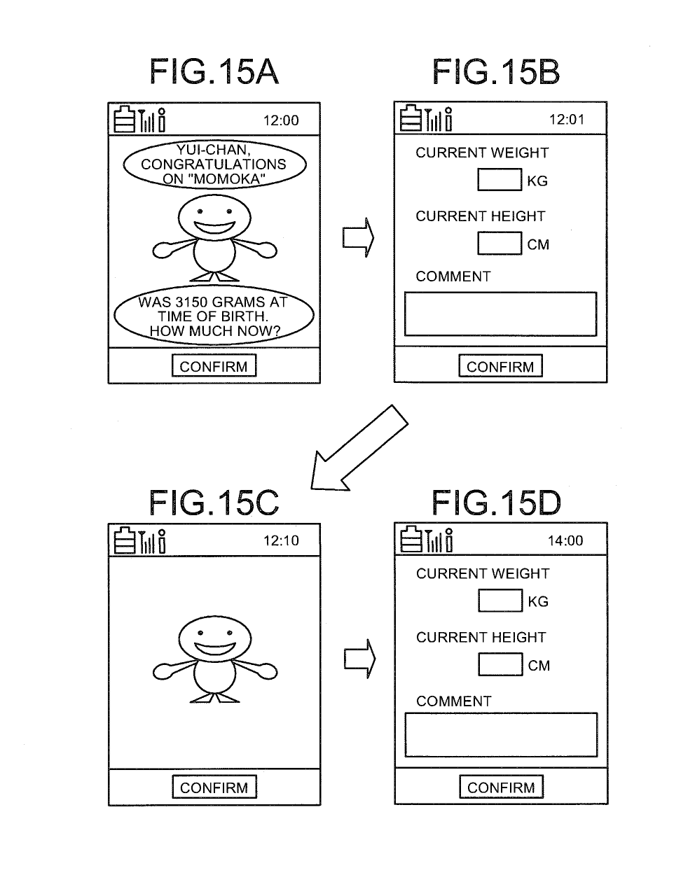

To be specific, after notifying that the anniversary has arrived, the mobile terminal activates the application intermittently at a predetermined time interval until the data related to the anniversary is recorded. In an example shown in FIGS. 15A to 15D, the mobile terminal notifies that the anniversary has arrived (see FIG. 15A) and activates the memo input application (see FIG. 15B). If the memo input application ends before the memo related to the anniversary is input (see FIG. 15C), the mobile terminal again activates the memo input application intermittently at the predetermined time interval (for example, in FIG. 15D, the mobile terminal activates the memo input application at 14:00 that is two hours after the previous activation of the memo input application). FIGS. 15A to 15D are schematics for explaining a feature of a mobile terminal according to the second embodiment that reactivates the application after a predetermined time period.

Thus, after notifying the anniversary, the mobile terminal activates the application intermittently at the predetermined time interval until the data related to the anniversary is recorded. Therefore, even if the user is not sufficiently keen to preserve the record of the anniversary, the record of the anniversary can be preserved at a timing convenient to the user.

In the first embodiment explained earlier, the mobile terminal displays in the display 12, the notification to the effect that the anniversary has arrived. However, the present invention is not to be thus limited, and the mobile terminal can also output a sound from the speaker to notify that the anniversary has arrived.

All the manual processes explained in the present embodiment can be, entirely or in part, carried out automatically in a known manner (for example, the anniversary can be input from a database or the like automatically). The sequence of processes, the sequence of controls, specific names, and data including various parameters (for example, FIGS. 3, 4, 5, 6, 7, 8A to 8C, 11, 12A to 12C, 13, 14, 15A to 15D etc.) can be changed as required unless otherwise specified.

The constituent elements of the device are shown in the drawings merely conceptually and functionally, and may not necessarily physically resemble the structures shown in the drawings. For instance, the device need not necessarily have the structure shown in the drawings. The device as a whole or in parts can be broken down or integrated either functionally or physically in accordance with the load or how the device is to be used (for example, the anniversary-determining unit 32 and the anniversary operation controller 33 shown in FIG. 2 can be integrated).

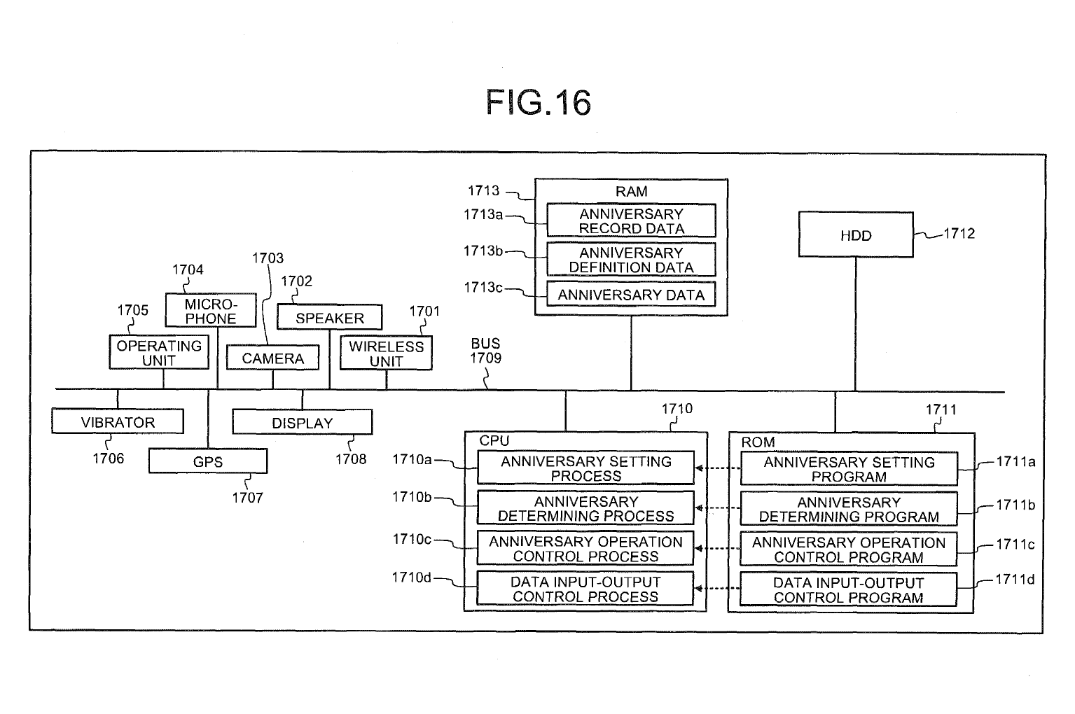

In the first embodiment, various processes are realized with the use of a hardware logic. However, the present invention is not to be thus limited, and the processes can also be realized by executing a prior formulated computer program using a computer. An example of the computer, which executes an anniversary notifying program that includes functions similar to the mobile terminal according to the first embodiment, is explained next with reference to FIG. 16. FIG. 16 is a block diagram of the anniversary notifying program according to the first embodiment.

As shown in FIG. 16, the mobile terminal includes a wireless unit 1701, a speaker 1702, a camera 1703, a microphone 1704, an operating unit 1705, a vibrator 1706, a GPS 1707, a display 1708, a central processing unit (CPU) 1710, a read only memory (ROM) 1711, a hard disk drive (HDD) 1712, and a random access memory (RAM) 1713 that are connected by a bus 1709.

The ROM 1711 prior stores a control program and an input-output control program that exhibit functions similar to the controller 30 and the input-output control interface 20 respectively that are explained in the first embodiment. In other words, as shown in FIG. 16, the ROM 1711 stores in advance an anniversary setting program 1711a, an anniversary determining program 1711b, an anniversary operation control program 1711c, and a data input-output control program 1711d. Similarly to the components of the mobile terminal shown in FIG. 2, the anniversary setting program 1711a, the anniversary determining program 1711b, the anniversary operation control program 1711c, and the data input-output control program 1711d can also be appropriately integrated or broken down.

The anniversary setting program 1711a, the anniversary determining program 1711b, the anniversary operation control program 1711c, and the data input-output control program 1711d are read by the CPU 1710 from the ROM 1711 and executed. Then, as shown in FIG. 16, the anniversary setting program 1711a, the anniversary determining program 1711b, the anniversary operation control program 1711c, and the data input-output control program 1711d function respectively as an anniversary setting process 1710a, an anniversary determining process 1710b, an anniversary operation control process 1710c, and a data input-output control process 1710d. The anniversary setting process 1710a, the anniversary determining process 1710b, the anniversary operation control process 1710c, and the data input-output control process 1710d correspond respectively to the anniversary-setting unit 31, the anniversary-determining unit 32, the anniversary operation controller 33, and the input-output control interface 20 that are shown in FIG. 2.

The CPU 1710 executes the anniversary notifying program based on anniversary record data 1713a, anniversary definition data 1713b, and anniversary data 1713c that are stored in the RAM 1713.

The anniversary setting program 1711a, the anniversary determining program 1711b, the anniversary operation control program 1711c, and the data input-output control program 1711d explained in the present embodiment need not be stored in the ROM 1711 from the beginning. For example, the anniversary setting program 1711a, the anniversary determining program 1711b, the anniversary operation control program 1711c, and the data input-output control program 1711d can be stored in a “portable physical medium” such as a memory card, a flexible disk (FD), a compact disk-read only memory (CD-ROM), a magneto optic (MO) disk, a digital versatile disk (DVD), and an integrated circuit (IC) card that can be inserted in the computer notifying the anniversary, or in a “fixed physical medium” such as an HDD that can be included inside or outside the computer notifying the anniversary, or in “another computer (or server)” that is connected to the computer notifying the anniversary via a public line, Internet, a local area network (LAN), a wide area network (WAN) etc. The anniversary setting program 1711a, the anniversary determining program 1711b, the anniversary operation control program 1711c, and the data input-output control program 1711d can be read by the computer notifying the anniversary from the media mentioned earlier and executed.

Further, an anniversary notifying method explained in the embodiments can be realized by executing the prior formulated computer program using a computer such as a personal computer or workstation. The computer program can be distributed via a network such as Internet. The computer program can also be recorded in a computer readable recording medium such as a hard disk, an FD, a CD-ROM, an MO disk, a DVD etc., and read by the computer for execution.

According to an embodiment of the present invention, a mobile terminal controls an operation of an application such that the application that causes data recording records data related to the anniversary around the same time that the anniversary is notified. Therefore, even if a user is not sufficiently keen to record the data related to the anniversary, the data related to the anniversary can be recorded.

According to an embodiment of the present invention, the mobile terminal monitors whether the user has carried out an operation on the mobile terminal after the anniversary is notified. If the user has carried out an operation on the mobile terminal, the mobile terminal controls the operation by activating the application. Therefore, a timing to activate the application can be controlled based on only whether the user has carried out an operation. Thus, a further simplified process is realized and the application can be activated during the timing when the user is carrying the mobile terminal.

According to an embodiment of the present invention, the mobile terminal controls the operation by activating as the application, the imaging application that shoots and records an image. Therefore, even if the user is not sufficiently keen to preserve a commemorative photograph, the commemorative photograph can be preserved.

According to an embodiment of the present invention, the mobile terminal controls the operation by activating as the application, the memo input application that receives and records a memo input. Therefore, even if the user is not sufficiently keen to preserve a memo related to the anniversary, the memo related to the anniversary can be preserved.

According to an embodiment of the present invention, the mobile terminal controls the operation by activating as the application, the mail application that transmits and records a mail. Due to this, even if the user is not sufficiently keen to transmit a mail related to the anniversary, the mail related to the anniversary can be transmitted.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program that causes a computer embodied in a mobile terminal to execute a method of notifying that an anniversary has arrived, the computer program causing the computer to execute:
anniversary operation controlling in which an operation, of an application that causes data recording, is controlled such that the application records data related to the anniversary around a same time that the anniversary is notified.

2. The computer-readable recording medium according to claim 1, wherein the anniversary operation controlling includes monitoring whether a user has carried out an operation on the mobile terminal after the anniversary is notified, and controlling, upon the user carrying out an operation on the mobile terminal, the operation by activating the application.

3. The computer-readable recording medium according to claim 1, wherein the anniversary operation controlling includes controlling the operation by activating as the application, an imaging application that shoots and records an image.

4. The computer-readable recording medium according to claim 1, wherein the anniversary operation controlling includes controlling the operation by activating as the application, a memo input application that receives and records a memo input.

5. The computer-readable recording medium according to claim 1, wherein the anniversary operation controlling includes controlling the operation by activating as the application, a mail application that transmits and records a mail.

6. The computer-readable recording medium according to claim 1, wherein the anniversary operation controlling includes controlling the operation by activating as the application, a log application that records as a log, an operation history of the mobile terminal.

7. The computer-readable recording medium according to claim 1, wherein the computer program causing the computer to further execute:
anniversary record storing that includes storing in a predetermined storage unit, a correspondence between the data related to the anniversary and the anniversary; and
anniversary data outputting that includes searching from the predetermined storage unit, around a same time that the anniversary is notified, data corresponding to a past anniversary related to the anniversary and outputting the searched data using the mobile terminal.

8. The computer-readable recording medium according to claim 4, wherein the anniversary operation controlling includes, when controlling the operation by activating the mail application, outputting to the mobile terminal, a mail for transmission in which a subject corresponding to the anniversary is prior written in a subject column.

9. The computer-readable recording medium according to claim 4, wherein the anniversary operation controlling includes, when controlling the operation by activating the mail application, outputting to the mobile terminal, a mail for transmission in which a mail address of a person related to the anniversary is prior written in an address column.

10. The computer-readable recording medium according to claim 1, wherein the anniversary operation controlling includes activating, after the anniversary is notified, the application intermittently at a predetermined time interval until the data related to the anniversary is recorded.

11. A method of notifying that an anniversary has arrived by a mobile terminal, comprising:
anniversary operation controlling in which an operation, of an application that causes data recording, is controlled such that the application records data related to the anniversary around a same time that the anniversary is notified.

12. A mobile terminal for notifying that an anniversary has arrived, comprising:
an anniversary operation controller that controls an operation, of an application that causes data recording, such that the application records data related to the anniversary around a same time that the anniversary is notified.
